(19) United States
(12) Patent Application Publication
(10) Pub. No.: US 2005/0185610 A1
(43) Pub. Date: Aug. 25, 2005

(54) Method and system for controlling communication direction of mobile station

(75) Inventor: Na-Young Cheon, Seocho-Gu (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: CURITEL COMMUNICATIONS, INC., Seocho-Gu (KR)

(21) Appl. No.: 11/062,797

(22) Filed: Feb. 23, 2005

(30) Foreign Application Priority Data
Feb. 23, 2004 (KR) 10-2004-0011959

(51) Int. Cl. H04L 1/00

(52) U.S. Cl. 370/328

(57) ABSTRACT

Disclosed is a method and system for controlling communication direction of a mobile station. The system includes: an overhead message receive unit for receiving an overhead message from a first base station; a first field value determination unit for determining whether a first field value is a first value or second value; a first field value change unit for comparing a current second field value with a previous second field value when the first field value is determined to be the first value, and changing the first field value to the second value if the current second field value does not match the previous second field value; and a processing execution unit for not performing operation of processing the overhead message if the current second field value matches the previous second field value and performing operation of processing the overhead message if the first field value indicates the second value.

### BACKGROUND OF THE INVENTION

This application claims the priority of Korean Patent Application No. 2004-11959, filed on Feb. 23, 2004, in the Korean Intellectual Property Office, the disclosure of which is incorporated herein in its entirety by reference.

1. Field of the Invention

The present invention relates to a method and system for controlling the communication direction of a mobile station and, more particularly, to a global service redirection/extended global service redirection (GSR/EGSR) mechanism for causing the mobile station to access a neighboring base station when the communication load of a serving base station exceeds a predetermined level.

2. Description of the Related Art

A pilot channel is a channel that allows a mobile station accessing a mobile network to locate a base station outputting a signal with the strongest signal strength among signals received from neighboring base stations.

The mobile station acquires system synchronization from the base station over the pilot channel, synchronizes timing with a mobile communication system according to a message received over a synchronization channel, and then continues to monitor a paging channel.

The paging channel is a channel that transfers messages such as supplementary information, paging command, and channel allocation information to mobile stations within an area governed by the base station. The messages that are transferred over the paging channel can be classified into two types: overhead messages, which are transferred to all of the mobile stations within the service coverage area of the base station, and personal station directed messages, which are transferred to a specific mobile station.

The overhead messages are periodically sent to the mobile stations to provide them with information about the base station, such as base station's location, identifier, operating frequency, or handoff operation, channels being currently used by the base station, registration areas for the mobile stations, or user zones, and other information necessary for the mobile stations to access the base station.

Examples of the overhead messages include a system parameters message, an access parameters message, a neighbor list message, a code division multiple access (CDMA) channel list message, an extended system parameters message, an extended neighbor list message, a global service redirection message, a general neighbor list message, a user zone identification message, a private neighbor list message, an extended global service redirection message, an extended CDMA channel list message, etc.

The global service redirection (GSR) message and the extended global service redirection (EGSR) message are used to cause the mobile stations to access a neighboring base station for the purpose of dispersing the communication load of the serving base station when the communication load of the serving base station exceeds a predetermined level.

When a specific one of the mobile stations receives the GSR/EGSR message, it stores information on a new base station and removes information on a current base station. That is, upon receiving the GSR/EGSR message, the specific mobile station stores the parameter CONFIG_MSG_SEQ contained in the received GSR/EGSR message in its own random access memory (RAM). Next, when the specific mobile station receives a new GSR/EGSR message, it compares the parameter CONFIG_MSG_SEQ contained in the new GSR/EGSR message with the stored parameter CONFIG_MSG_SEQ to determine whether or not the stored parameter CONFIG_MSG_SEQ match the parameter CONFIG_MSG_SEQ contained in the new GSR/EGSR message. If the parameters are determined not to match each other, the specific mobile station replaces the stored parameter with the parameter contained in the new GSR/EGSR message. The specific mobile station then changes its communication direction from the current base station to the new base station according to the stored information.

FIGS. 4 and 5 show parameters contained in the GSR and EGSR messages.

The parameter BAND_CLASS represents a frequency band of the new base station. The parameter EXPECTED_SID represents an expected system identifier (SID) of the new base station. The parameter EXPECTED_NID represents an expected network identifier (NID) of the new base station. The parameter CDMA_CHAN represents a channel of the new base station. The mobile station changes its communication direction to the new base station with reference to the above-mentioned parameters.

The parameter CONFIG_MSG_SEQ is a parameter used to determine whether or not the GSR/EGSR message has been changed.

The parameter RETURN_IF_FAIL is set to TRUE or FALSE. If the parameter RETURN_IF_FAIL is set to TRUE, the mobile station returns to the current base station when the new base station is not available. On the contrary, if the parameter RETURN_IF_FAIL is set to FALSE, the mobile station searches for other neighboring base stations to access a proper one of them when the new base station is not available.

Conventionally, in the case where the parameter RETURN_IF_FAIL contained in the GSR/EGSR message is set to TRUE, the mobile station returns to an original base station when a new base station is not available, and in turn resumes the above-mentioned operation of processing the GSR/EGSR message.

Consequently, such a repetitive operation in the mobile station contributes to increased battery consumption in the mobile station. Further, since the mobile station has not yet completed the registration with the base station during the repetitive operation, the quality of services which are provided by mobile carriers, such as voice call service, becomes deteriorated.

### SUMMARY OF THE INVENTION

The present invention provides a method and system for controlling the communication direction of a mobile station, which is capable of determining whether the mobile station will resume the operation of processing a global service redirection/extended global service redirection (GSR/EGSR) message when returning to an original base station due to unavailability of a new base station indicated by the GSR/EGSR message.

In accordance with an aspect of the present invention, there is provided a system for controlling the communication direction of a mobile station, comprising: an overhead message receive unit for receiving from a first base station an overhead message associated with service redirection; a first field value determination unit for determining whether a first field value is a first value (TRUE) or a second value (FALSE), the first field value being contained in the overhead message and indicating whether or not to repeat the operation of processing the overhead message; a first field value change unit for comparing a current second field value with a previous second field value when the first field value is determined to be the first value by the first field value determination unit, and changing the first field value to the second value if the current second field value does not match the previous second field value, wherein the second field value is contained in the overhead message and indicates whether there is a change in a service redirection command; and a processing execution unit for not performing the operation of processing the overhead message if the current second field value matches the previous second field value and performing the operation of processing the overhead message if the first field value indicates the second value.

The processing execution unit may comprise: an access request unit for requesting access from a second base station indicated by the received overhead message and receiving response information from the second base station if the first field value is determined to be the second value by the first field value determination unit or if it is changed to the second value by the first field value change unit; an availability determination unit for determining from the response information received from the second base station whether or not the second base station is available; and a communication redirection unit for changing the communication direction of the mobile station to the second base station if the second base station is determined to be available by the availability determination unit.

Upon failing to acquire a pilot channel signal from the first base station, the communication redirection unit may be adapted to change the first field value to the second value, search for available neighboring base stations, select a proper one of the available base stations, and change the communication direction of the mobile station to the selected base station.

The first field value change unit may be adapted to store the received overhead message in memory means of the mobile station if the current second field value does not match the previous second field value.

The second base station may be indicated by system/network-related values contained in the received overhead message.

The overhead message may be a GSR/EGSR message and the second field value may be the parameter CONFIG_MSG_SEQ contained in the GSR/EGSR message.

The selected base station may be one which outputs a signal with the strongest signal strength among signals received over a pilot channel.

In accordance with another aspect of the present invention, there is provided a method of controlling the communication direction of a mobile station, the method comprising the steps of: receiving an overhead message associated with service redirection from a first base station; determining whether a first field value is a first value (TRUE) or second value (FALSE), the first field value being contained in the overhead message and indicating whether or not to repeat the operation of processing the overhead message; determining whether or not a second field value contained in the overhead message has been changed when the first field value is determined to be the first value, and changing the first field value to the second value if the second field value has been changed; requesting access from a second base station indicated by the overhead message and receiving response information from the second base station, if the first field value is determined to be the second value or if it is changed to the second value; determining from the response information received from the second base station whether or not the second base station is available; and changing the communication direction of the mobile station to the second base station if the second base station is determined to be available.

The step of changing the communication direction may further comprise: checking a third field value to determine whether it is the first value or the second value when the second base station is determined to be not available, wherein the third field value is contained in the overhead message and indicates whether or not the mobile station returns to the first base station upon failure of the service redirection; changing the first field value to the first value if the third field value is determined to be the first value; and searching for available neighboring base stations if the third field value is determined to be the second value, and changing the communication direction of the mobile station to a proper one of the available base stations.

The step of changing the communication direction may further comprise the steps of: changing the first field value to the second value upon failing to acquire a pilot channel signal from the first base station; and searching for available neighboring base stations and changing the communication direction of the mobile station to a proper one of the available base stations.

The step of changing the first field value to the second value may comprise the step of storing the overhead message in memory means of the mobile station if the second field value has been changed.

Upon searching for available neighboring base stations and changing the communication direction of the mobile station to one of the available base stations, the step of changing the communication direction may comprise the step of selecting a base station which outputs a signal with the strongest signal strength among signals received over a pilot channel.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view showing a system for controlling the communication direction of a mobile station in accordance with the present invention;

FIG. 2 is a block diagram showing a communication direction control system in accordance with an embodiment of the present invention;

FIG. 3 is a flowchart showing a method of controlling the communication direction of a mobile station in accordance with the present invention;

FIG. 4 is a table showing parameters contained in a global service redirection (GSR) message; and

FIG. 5 is a table showing parameters contained in an extended global service redirection (EGSR) message.

### DESCRIPTION OF THE PREFERRED EMBODIMENTS

Exemplary embodiments of the present invention will now be described in detail with reference to the accompanying drawings.

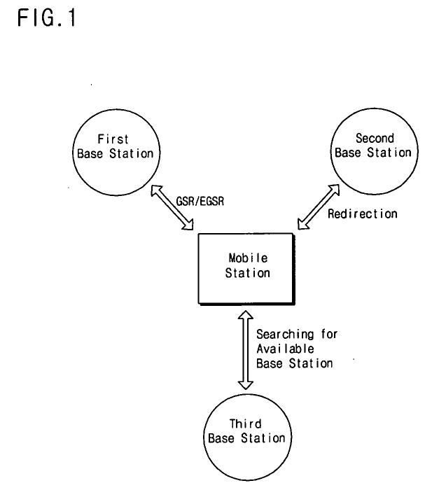

FIG. 1 is a schematic view showing a system for controlling the communication direction of a mobile station in accordance with the present invention.

The communication direction control system in accordance with the present invention is implemented in the form of software that can be run in the mobile station. When a first base station communicating with the mobile station has a communication load greater than a predetermined level, the first base station sends a global service redirection/extended global service redirection (GSR/EGSR) message to the mobile station to cause it to access a neighboring second base station for the purpose of dispersing the communication load of the first base station. Upon receiving the GSR/EGSR message from the first base station, the communication direction control system performs a process of changing the communication direction of the mobile station from the first base station to the second base station according to the received GSR/EGSR message.

In this case, the communication direction control system attempts to access the second base station indicated by the received GSR/EGSR message to determine whether or not the second base station is available. When the second base station is determined to be available, the control system changes the communication direction of the mobile station to the second base station. However, when the second base station is determined to be not available, the control system returns to the original base station, i.e., the first base station, and searches for and accesses an available third base station according to the parameter RETURN_IF_FAIL contained in the GSR/EGSR message. Otherwise, if the GSR/EGSR message is not a changed one, the control system sets the field value Fail_Flag contained in the GSR/EGSR message so that the operation of processing the GSR/EGSR message cannot be repeated.

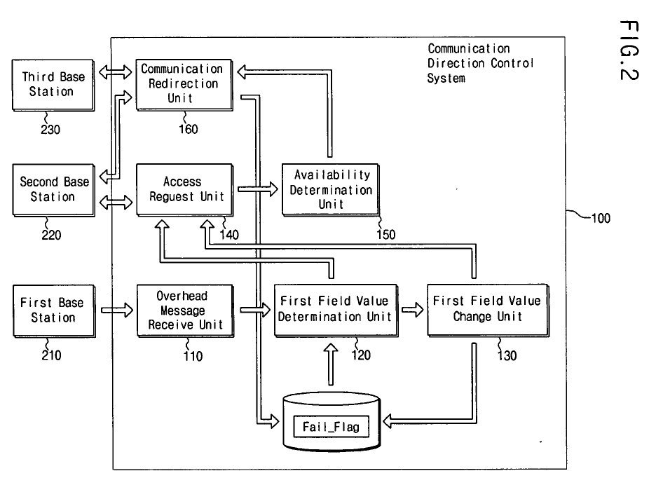

FIG. 2 is a block diagram showing a communication direction control system in accordance with an embodiment of the present invention.

The communication direction control system 100 comprises an overhead message receive unit 110, a first field value determination unit 120, a first field value change unit 130, an access request unit 140, an availability determination unit 150, and a communication redirection unit 160.

The overhead message receive unit 110 is adapted to receive a GSR/EGSR message from a first base station 210.

When the first base station 210 has a communication load greater than a predetermined level, the base station 210 sends the GSR/EGSR message to the mobile station within its service coverage area over a paging channel to cause it to access a neighboring second base station 220. The communication direction control system 100, which is implemented in the form of software that can be run in the mobile station, receives the GSR/EGSR message from the first base station 210 through the overhead message receive unit 110.

The first field value determination unit 120 is adapted to determine whether a first field value Fail_Flag contained in the GSR/EGSR message received by the overhead message receive unit 110 is a first value (TRUE) or a second value (FALSE).

That is, in the case where the mobile station returns to the first base station 210 due to unavailability of the second base station 220 indicated by the GSR/EGSR message, the first field value Fail_Flag is used to determine whether the communication direction control system 100 should resume or terminate the operation of processing the GSR/EGSR message.

In the present invention, the communication direction control system 100 terminates the operation of processing the GSR/EGSR message when the first field value Fail_Flag is a first value (hereinafter referred to as ‘TRUE’), and resumes the above-mentioned operation when the first field value Fail_Flag is a second value (hereinafter referred to as ‘FALSE’).

The first field value change unit 130 is adapted to determine whether the parameter CONFIG_MSG_SEQ contained in the GSR/EGSR message has been changed when the first field value Fail_Flag is determined to be TRUE by the first field value determination unit 120. The first field value change unit 130 terminates the operation of processing the GSR/EGSR message when the parameter CONFIG_MSG_SEQ has not been changed. However, when the parameter CONFIG_MSG_SEQ has been changed, the first field value change unit 130 changes the first field value Fail_Flag to FALSE.

Preferably, the first field value change unit 130 stores the received GSR/EGSR message in memory means of the mobile station, such as RAM, when the parameter CONFIG_MSG_SEQ has been changed.

In other words, when the mobile station receives the GSR/EGSR message from the first base station 210, then it stores the parameter CONFIG_MSG_SEQ contained in the received GSR/EGSR message in the memory means. When the mobile station receives a new GSR/EGSR message, the first field value change unit 130 compares the parameter CONFIG_MSG_SEQ contained in the new GSR/EGSR message with the parameter CONFIG_MSG_SEQ stored in the memory means to determine whether or not the stored parameter CONFIG_MSG_SEQ match the parameter CONFIG_MSG_SEQ contained in the new GSR/EGSR message. When they are determined not to match each other, the first field value change unit 130 replaces the stored parameter CONFIG_MSG_SEQ with the parameter CONFIG_MSG_SEQ contained in the new GSR/EGSR message and then changes the first field value Fail_Flag to FALSE.

On the contrary, when the parameter CONFIG_MSG_SEQ stored in the memory means is determined to match the parameter CONFIG_MSG_SEQ contained in the new GSR/EGSR message, the first field value change unit 130 terminates the operation of processing the GSR/EGSR message and then returns to a mobile idle state. Accordingly, it is possible to avoid the operation of processing the GSR/EGSR message from being repeated unnecessarily, thereby significantly reducing battery consumption in the mobile station and enhancing the quality of services provided by mobile carriers.

If the first field value Fail_Flag is determined to be FALSE by the first field value determination unit 120, or if it is changed to FALSE by the first field value change unit 130, the access request unit 140 is adapted to request access from the second base station 220 indicated by the received GSR/EGSR message and receive response information from the second base station 220.

That is, in the case of resuming the operation of processing the GSR/EGSR message due to the setting of the first field value Fail_Flag to FALSE, the communication direction control system 100 requests access from the second base station 220 indicated by the received GSR/EGSR message through the access request unit 140.

The second base station 220 is indicated by parameters BAND_CLASS, CDMA_CHAN, EXPECTED_SID, and EXPECTED_NID contained in the received GSR/EGSR message, where the parameter BAND_CLASS represents a frequency band of the new base station to which the communication is to be redirected, the parameter EXPECTED_SID represents an expected system identifier (SID) of the new base station, the parameter EXPECTED_NID represents an expected network identifier (NID) of the new base station, and the parameter CDMA_CHAN represents a channel of the new base station.

The availability determination unit 150 is adapted to determine from the response information, which is received from the second base station 220 through the access request unit 140, whether or not the second base station 220 is available.

The second base station 220 is determined to be available when the mobile station can receive services provided from mobile carriers by acquiring a pilot channel from the second base station 200 to establish synchronization with the second base station 200, obtaining overhead messages from the second base station 200 over the paging channel, and completing the registration with the second base station 200. The availability determination unit 150 monitors the above-mentioned operation to determine whether or not the second base station 220 is available.

The communication redirection unit 160 is adapted to change the communication direction of the mobile station to the second base station 220 if the second base station 220 is determined to be available by the availability determination unit 150.

That is, if the availability determination unit 150 in the communication direction control system 100 determines the second base station 220 to be available, then the communication direction control system 100 changes the communication direction of the mobile station to the second base station 220 through the communication redirection unit 160 so that the mobile station can receive various services such as voice call service, which are provided by mobile carriers, through the second base station 220.

Consequently, the communication direction control system 100 in accordance with the present invention avoids the operation of processing the GSR/EGSR message from being repeated unnecessarily by the mobile station when the mobile station returns to a first base station due to unavailability of a new base station indicated by the GSR/EGSR message, thereby making it possible to significantly reduce battery consumption in the mobile station and enhance the quality of services provided by mobile carriers.

According to a preferred embodiment of the present invention, in the case where the second base station 220 is determined to be not available by the availability determination unit 150, the communication redirection unit 160 checks the parameter RETURN_IF_FAIL contained in the GSR/EGSR message to determine whether it is TRUE or FALSE. The communication redirection unit 160 changes the first field value Fail_Flag to TRUE if the parameter RETURN_IF_FAIL is TRUE. On the contrary, if the parameter RETURN_IF_FAIL is FALSE, the communication redirection unit 160 searches for available neighboring base stations and changes the communication direction of the mobile station to a proper one of the available base stations.

In other words, if the availability determination unit 150 determines the second base station 220 to be available, the communication direction control system 100 changes the communication direction of the mobile station to the second base station 220 through the communication redirection unit 160. However, when the second base station 220 is determined to be not available, the communication direction control system 100 checks the parameter RETURN_IF_FAIL contained in the received GSR/EGSR message through the communication redirection unit 160 to determine whether it is TRUE or FALSE.

If the parameter RETURN_IF_FAIL is TRUE, the mobile station returns to the first base station 210 due to unavailability of the second base station 220 indicated by the GSR/EGSR message. On the contrary, if the parameter RETURN_IF_FAIL is FALSE, the mobile station searches for other neighboring base stations and then accesses a proper one of them, e.g., a third base station 230, due to unavailability of the second base station 220.

If the parameter RETURN_IF_FAIL is determined to be TRUE, the communication direction control system 100 changes the first field value Fail_Flag to TRUE through the communication redirection unit 160 and then returns to a mobile idle state.

In the case where the parameter RETURN_IF_FAIL is determined to be FALSE, the communication direction control system 100, through the communication redirection unit 160, searches for available neighboring base stations and changes the communication direction of the mobile station to a proper one of the available base stations, e.g., the third base station 230, so that the mobile station can receive various services such as voice call service, provided by mobile carriers, through the third base station 230.

In this case, the third base station 230 is one which outputs a signal with the strongest signal strength among signals received over a pilot channel.

In accordance with another preferred embodiment of the present invention, upon failing to acquire the pilot channel from the first base station 210, the communication redirection unit 160 changes the first field value Fail_Flag to FALSE, searches for available neighboring base stations, and changes the communication direction of the mobile station to a proper one of the available base stations.

At this time, the communication redirection unit 160 selects a base station outputting a signal with the strongest signal strength among signals received over the pilot channel.

In other words, the mobile station acquires system synchronization from the first base station 210 over the pilot channel, synchronizes timing with a mobile communication system according to a message received over a synchronization channel, and then continues to monitor the paging channel. When the mobile station fails to acquire a pilot channel signal from the first base station 210 while monitoring the paging channel, i.e., when the signal strength of the first base station 210 is lower than a reference value, the communication direction control system 100, through the communication redirection unit 160, changes the first field value Fail_Flag to FALSE, detects the signal strengths of neighboring base stations over the pilot channel, selects a base station with the strongest one of the detected signal strengths, e.g., the third base station 230, among the neighboring base stations, and changes the communication direction of the mobile station to the selected third base station 230, so that a user can use various services such as voice call service, provided by mobile carriers, through the third base station 230.

According to the present invention, when the mobile station returns to a first base station due to unavailability of a new base station indicated by the GSR/EGSR message, it is possible to avoid the operation of processing the GSR/EGSR message from being repeated unnecessarily since the communication direction control system 100 is implemented to carry out the process of determining whether the mobile station should resume or terminate the operation of processing the GSR/EGSR message. Further, it is possible to significantly reduce battery consumption in the mobile station and enhancing the quality of services provided by mobile carriers.

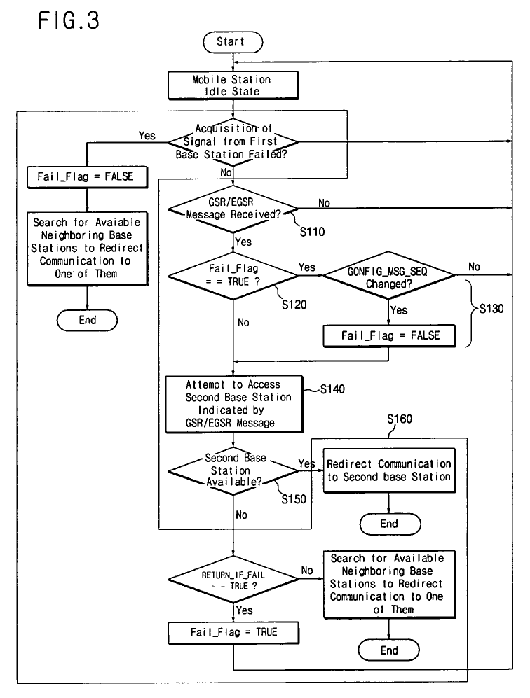

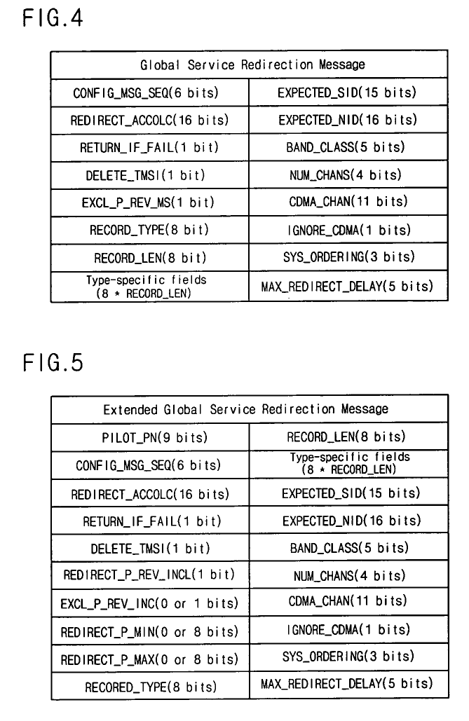

A detailed description will now be given of the communication redirection process in the communication direction control system in accordance with the present invention with reference to FIG. 3.

FIG. 3 is a flowchart showing a method of controlling the communication direction of a mobile station in accordance with the present invention.

The communication direction control method comprises an overhead message receiving step S110, a first field value determining step S120, a first field value changing step S130, an access requesting step S140, an availability determining step S150, and a communication direction changing step S160.

When a first base station has a communication load greater than a predetermined level, it sends a GSR/EGSR message to a mobile station within its service coverage area over a paging channel to cause the mobile station to access a neighboring second base station. The mobile station receives the GSR/EGSR message sent from the first base station at the overhead message receiving step S110.

At the first field value determining step S120, the mobile station determines whether the first field value Fail_Flag contained in the GSR/EGSR message is TRUE or FALSE. Here, the first field value Fail_Flag is used to determine whether or not to repeat the operation of processing the received GSR/EGSR message.

When the first field value Fail_Flag is determined to be TRUE, the mobile station determines, at the first field value changing step S130, whether the parameter CONFIG_MSG_SEQ contained in the GSR/EGSR message has been changed. Further, the mobile station changes the first field value Fail_Flag to FALSE when the parameter CONFIG_MSG_SEQ has been changed.

Preferably, at the first field value changing step S130, the mobile station stores the received GSR/EGSR message in its memory means when the parameter CONFIG_MSG_SEQ has been changed.

If the parameter CONFIG_MSG_SEQ contained in the GSR/EGSR message has not been changed, the mobile station terminates the operation of processing the GSR/EGSR message and then returns to an idle state. Accordingly, it is possible to avoid the operation of processing the GSR/EGSR message from being repeated unnecessarily.

On the other hand, if the first field value Fail_Flag is determined to be FALSE at the first field value determining step S120, or if it is changed to FALSE at the first field value changing step S130, the mobile station requests access from the second base station indicated by the received GSR/EGSR message and receives response information from the second base station at the access requesting step S140.

At this time, the second base station is indicated by parameters BAND_CLASS, CDMA_CHAN, EXPECTED_SID and EXPECTED_NID contained in the received GSR/EGSR message.

At the availability determining step S150, the mobile station determines from the response information received from the second base station whether the second base station is available.

If the second base station is determined to be available at the availability determining step S150, the mobile station changes the communication direction to the second base station at the communication direction changing step S160.

Accordingly, it is possible to avoid the operation of processing the GSR/EGSR message from being repeated unnecessarily when the mobile station returns to an original base station due to unavailability of a new base station indicated by the GSR/EGSR message, thereby reducing battery consumption in the mobile station and enhancing the quality of services provided by mobile carriers.

In the case where the second base station is determined to be not available at the availability determining step S150, the mobile station checks the parameter RETURN_IF_FAIL contained in the received GSR/EGSR message at the communication direction changing step S160 to determine whether it is TRUE or FALSE. At the communication direction changing step S160, the mobile station changes the first field value Fail_Flag to TRUE if the parameter RETURN_IF_FAIL is TRUE. On the contrary, if the parameter RETURN_IF_FAIL is FALSE, the mobile station searches for available neighboring base stations and changes the communication direction to a proper one of the available base stations.

If the parameter RETURN_IF_FAIL is TRUE, the mobile station returns to the first base station when the second base station indicated by the GSR/EGSR message is not available. On the contrary, if the parameter RETURN_IF_FAIL is FALSE, the mobile station searches for other neighboring base stations and then accesses a proper one of the base stations, e.g., a third base station, when the second base station is not available.

If the parameter RETURN_IF_FAIL is determined to be TRUE, the mobile station changes the first field value Fail_Flag to TRUE at the communication direction changing step S160 and then returns to the idle state.

At the communication direction changing step S160, if the parameter RETURN_IF_FAIL is determined to be FALSE, the mobile station searches for available neighboring base stations and changes the communication direction to a proper one of the available base stations, e.g., the third base station, thereby receiving various services such as voice call service, provided by mobile carriers, through the third base station.

At this time, the third base station is one which outputs a signal with the strongest signal strength among signals received over a pilot channel.

At the communication direction changing step S160, if the mobile station fails to acquire a pilot channel signal from the first base station, it changes the first field value Fail_Flag to FALSE, searches for available neighboring base stations, and changes the communication direction to a proper one of the available base stations.

At this time, the mobile station selects a base station outputting a signal with the strongest signal strength among signals received over the pilot channel.

That is, the mobile station acquires system synchronization from the first base station over the pilot channel, synchronizes timing with a mobile communication system according to a message received over a Sync channel, and then continues to monitor the paging channel. When the mobile station fails to acquire a pilot channel signal from the first base station while monitoring the paging channel, i.e., when the signal strength of the first base station is lower than a reference value, the mobile station, at the communication direction changing step S160, changes the first field value Fail_Flag to FALSE, detects the signal strengths of neighboring base stations over the pilot channel, selects a base station with the strongest one of the detected signal strengths, e.g., the third base station, among the neighboring base stations, and changes the communication direction of the mobile station to the selected third base station, so that a user can use various services such as voice call service, provided by mobile carriers, through the third base station.

The values of Fail_Flag, CONFIG_MSG_SEQ, and RETURN_IF_FAIL in the above-mentioned embodiments will be referred to as first, second, and third field values, respectively, in the following claims. In addition, the access request unit 140, availability determination unit 150, and communication redirection unit 160, which are provided in the communication direction control system 100 in accordance with the present invention, will be collectively referred to as a processing execution unit in the following claims.

While the present invention has been described with reference to exemplary embodiments thereof, it will be understood by those skilled in the art that various changes in form and details may be made therein without departing from the scope of the present invention as defined by the following claims.

1. A system for controlling the communication direction of a mobile station, comprising:
an overhead message receive unit for receiving from a first base station an overhead message associated with service redirection;
a first field value determination unit for determining whether a first field value is a first value (TRUE) or a second value (FALSE), the first field value being contained in the overhead message and indicating whether or not to repeat the operation of processing the overhead message;
a first field value change unit for comparing a current second field value with a previous second field value when the first field value is determined to be the first value by the first field value determination unit, and changing the first field value to the second value if the current second field value does not match the previous second field value, wherein the second field value is contained in the overhead message and indicates whether there is a change in a service redirection command; and
a processing execution unit for not performing the operation of processing the overhead message if the current second field value matches the previous second field value and performing the operation of processing the overhead message if the first field value indicates the second value.

2. The system of claim 1, wherein the processing execution unit comprises:
an access request unit for requesting access from a second base station indicated by the received overhead message and receiving response information from the second base station if the first field value is determined to be the second value by the first field value determination unit or if it is changed to the second value by the first field value change unit;
an availability determination unit for determining from the response information received from the second base station whether or not the second base station is available; and
a communication redirection unit for changing the communication direction of the mobile station to the second base station if the second base station is determined to be available by the availability determination unit.

3. The system of claim 2, wherein upon failing to acquire a pilot channel signal from the first base station, the communication redirection unit is adapted to change the first field value to the second value, search for available neighboring base stations, select a proper one of the available base stations, and change the communication direction of the mobile station to the selected base station.

4. The system of claim 1, wherein the first field value change unit is adapted to store the received overhead message in memory means of the mobile station if the current second field value does not match the previous second field value.

5. The system of claim 2, wherein the second base station is indicated by system/network-related values contained in the received overhead message.

6. The system of claim 3, wherein the second base station is indicated by system/network-related values contained in the received overhead message.

7. The system of claim 1, wherein the overhead message is a GSR/EGSR (global service redirection/extended global service redirection) message and the second field value is the parameter CONFIG_MSG_SEQ contained in the GSR/EGSR message.

8. The system of claim 3, wherein the selected base station is one which outputs a signal with the strongest signal strength among signals received over a pilot channel.

9. A method of controlling the communication direction of a mobile station, the method comprising the steps of:
receiving an overhead message associated with service redirection from a first base station;
determining whether a first field value is a first value (TRUE) or second value (FALSE), the first field value being contained in the overhead message and indicating whether or not to repeat the operation of processing the overhead message;
determining whether or not a second field value contained in the overhead message has been changed when the first field value is determined to be the first value, and changing the first field value to the second value if the second field value has been changed;
requesting access from a second base station indicated by the overhead message and receiving response information from the second base station, if the first field value is determined to be the second value or if it is changed to the second value;
determining from the response information received from the second base station whether or not the second base station is available; and
changing the communication direction of the mobile station to the second base station if the second base station is determined to be available.

10. The method of claim 9, wherein the step of changing the communication direction further comprises:
checking a third field value to determine whether it is the first value or the second value when the second base station is determined to be not available, wherein the third field value is contained in the overhead message and indicates whether or not the mobile station returns to the first base station upon failure of the service redirection;
changing the first field value to the first value if the third field value is determined to be the first value; and
searching for available neighboring base stations if the third field value is determined to be the second value, and changing the communication direction of the mobile station to a proper one of the available base stations.

11. The method of claim 10, wherein the step of changing the communication direction further comprises the steps of:
changing the first field value to the second value upon failing to acquire a pilot channel signal from the first base station; and
searching for available neighboring base stations and changing the communication direction of the mobile station to a proper one of the available base stations.

12. The method of claim 9, wherein the step of changing the first field value to the second value comprises the step of storing the overhead message in memory means of the mobile station if the second field value has been changed.

13. The method of claim 9, wherein in the step of requesting access, the second base station is indicated by system/network-related values contained in the received overhead message.

14. The method of claim 10, wherein in the step of requesting access, the second base station is indicated by system/network-related values contained in the received overhead message.

15. The method of claim 11, wherein in the step of requesting access, the second base station is indicated by system/network-related values contained in the received overhead message.

16. The method of claim 12, wherein in the step of requesting access, the second base station is indicated by system/network-related values contained in the received overhead message.

17. The method of claim 10, wherein upon searching for available neighboring base stations and changing the communication direction of the mobile station to one of the available base stations, the step of changing the communication direction comprises the step of selecting a base station which outputs a signal with the strongest signal strength among signals received over a pilot channel.

18. The method of claim 11, wherein upon searching for available neighboring base stations and changing the communication direction of the mobile station to one of the available base stations, the step of changing the communication direction comprises the step of selecting a base station which outputs a signal with the strongest signal strength among signals received over a pilot channel.
